(19) United States
(12) Patent Application Publication
(10) Pub. No.: US 2007/0282025 A1
(43) Pub. Date: Dec. 6, 2007

(54) Very Small-Diameter Open-Cell Polymer Foams and Their Manufacturing Process

(76) Inventors: Remy Collier, Dijon (FR); Patrick Vedrenne, Dijon (FR); Marc Perez, Mille (FR)

Correspondence Address: THELEN REID BROWN RAYSMAN & STEINER LLP, P. O. BOX 640640, SAN JOSE, CA, 95164-0640, US

(21) Appl. No.: 10/581,978

(22) PCT Filed: Dec. 16, 2004
(86) PCT No.: PCT/FR04/50712

§ 371 Date: Apr. 2, 2007

(30) Foreign Application Priority Data
Dec. 19, 2003 (FR) 0351136

(51) Int. Cl. C08F 2/32

(52) U.S. Cl. 521/64; 521/130; 521/146

(57) ABSTRACT

The invention relates to novel foams obtained by highly concentrated internal phase emulsion polymerization, which are formed from a crosslinked, exclusively hydrocarbon, polymer based on styrenic monomers, and having a density of 40 to 260 mg/cm3 and cells with a mean diameter of 10 microns or less. It also relates to the process for manufacturing these foams.

### TECHNICAL FIELD

The present invention relates to very small-diameter open-cell polymer foams and to their manufacturing process.

The foams according to the invention are “polyHIPE” foams, that is to say foams obtained by polymerization of a highly concentrated internal phase emulsion, which are characterized by having not only open cells of very small diameter, but also a low density and a very high degree of purity.

They are thus of particular use in carrying out experiments in the field of plasma physics and in particular as targets for the study of inertial confinement fusion phenomena but also as materials intended to absorb energy (thermal, sound or mechanical insulation, and the like) or liquids, materials for the filtration and separation of substances, supports for impregnation with and/or for controlled release of substances (catalyst supports, vehicle for medicinal active principles, and the like) or as fillers for structures for which it is desired to lighten the weight.

### STATE OF THE PRIOR ART

“PolyHIPE” (Polymerized High Internal Phase Emulsion) foams are polymer foams which are obtained by polymerization of an emulsion composed, on the one hand, of a dispersing organic phase which comprises polymerizable monomers and a surface-active agent in solution in a solvent and, on the other hand, of a dispersed aqueous phase which represents at least 74% of the total volume of emulsion and which includes an initiator for polymerization of said monomers.

After removing the water present in the product resulting from this polymerization, open-cell foams are obtained, which cells correspond to the imprint of the water bubbles being formed in the emulsion during its preparation and which are interconnected via openings which are smaller in size than them, commonly denoted under the term “pores”.

These foams exhibit a high void volume/solid volume ratio and thus a low density, as well as an isotropic, spherical and uniform cell structure, making them very different from the conventional polymer foams obtained by blowing or extrusion, which are characterized by an anisotropic, oriented and nonuniform cell structure.

Due to their characteristics, “polyHIPE” foams are the subject of increasing interest and their use has been proposed in numerous fields, including in particular the manufacture of disposable absorbent articles (U.S. Pat. No. 5,331,015 [1]), of insulating articles (U.S. Pat. No. 5,770,634 [2]) and of filtration membranes and devices (WO-A-97/37745 [3]).

In order to further broaden their application potential, the inventors set themselves the objective of providing polyHIPE foams having cells with the smallest possible diameter, while maintaining a low density.

Moreover, they set themselves the objective of providing polyHIPE foams which have, in addition to the abovementioned properties, a very high degree of purity and which can be prepared by a process that is simple to implement and which is compatible economically with manufacture on the industrial scale.

### SUMMARY OF THE INVENTION

These objectives, and others besides, are achieved by the present invention, which proposes a polyHIPE foam formed from a crosslinked, exclusively hydrocarbon, polymer based on styrenic monomers and having a density of 40 to 260 mg/cm³ and cells with a mean diameter of 10 micrometers or less.

According to a first advantageous embodiment of the invention, the polymer is a styrene/divinylbenzene copolymer.

This copolymer may especially be obtained from commercially available styrene and divinylbenzene monomers, in which case the divinylbenzene is composed of a mixture of the three, ortho, meta and para, isomeric forms, with the meta form being predominant.

Advantageously, in this copolymer, the styrene/divinylbenzene weight ratio is between 5 and 1, preferably equal to 4 or approximately equal to 4.

According to the invention, the foam preferably has cells with a mean diameter of between 1 and 5 micrometers.

According to another advantageous embodiment of the invention, the foam has a mass content of impurities of less than 3%, or even less than 2%, that is to say the elements present in this foam other than the constituent carbon and constituent hydrogen of the polymer, represent less than 3%, or even less than 2%, by weight of said foam.

A foam according to the invention may especially be obtained by introducing, into a conventional process for highly concentrated internal phase emulsion polymerization, an additional step that consists in subjecting the emulsion to shear in order to reduce the diameter of the water bubbles that it contains, before the polymerization is carried out.

The subject of the invention is therefore also a process for manufacturing a polyHIPE foam as defined above, which comprises the following steps:

a) an emulsion between an organic phase, comprising exclusively hydrocarbon styrenic monomers and a surfactant, and an aqueous phase, comprising an electrolyte and a

b) the emulsion is subjected to shear in order to reduce the diameter of the water bubbles that it contains;

c) said monomers are polymerized until a solid foam is obtained; and

d) the foam thus obtained is washed and dried.

According to one advantageous provision of this process, the styrenic monomers present in the organic phase are styrene and divinylbenzene monomers, in a weight ratio of between 5 and 1, which preferably represent 50 to 80% by weight of the organic phase.

According to another advantageous provision of this process, the surfactant present in the organic phase is diglyceryl monooleate, having a hydrophilic-liophilic balance of 5.5, the inventors having found in fact that the use of this surfactant makes it possible to further reduce the diameter of the water bubbles present in the emulsion and, thereby, the diameter of the cells of the foams obtained.

However, other surfactants may also be used, such as for example sorbitan monooleate or diglyceryl monostearate.

In all cases, the surfactant preferably represents 13 to 20% by weight of the weight of this organic phase.

The electrolyte present in the aqueous phase, the role of which is to stabilize the emulsion by modifying the properties of the surfactant, is advantageously aluminum sulfate and preferably represents from 0.05 to 2% by weight of the weight of this aqueous phase. However, this electrolyte can also be chosen from various other salts, for example of aluminum, of copper or of sodium.

The polymerization initiator is, for its part, advantageously sodium persulfate and preferably represents from 0.1 to 2% by weight of the weight of the aqueous phase.

Furthermore, it is preferable to use, in the aqueous phase, ultrapure water, in particular water with a resistivity of close to or equal to 18.2 megaohms (MΩ), for example obtained by nanofiltration, ultrafiltration, ion exchange or distillation, this being because the level of purity of the water used has an effect on the purity of the foam obtained.

In accordance with the invention, the emulsion between the organic phase and the aqueous phase is produced, for example in a reactor equipped with a stirrer shaft, by gradually adding, with moderate stirring, the aqueous phase to the organic phase already present in the reactor and by then subjecting the combined mixture to more vigorous stirring, for example corresponding to a rotational speed of the shaft of 300 revolutions/min, until a stable emulsion is obtained. A stable emulsion is generally obtained by maintaining the stirring for 60 to 90 minutes.

The emulsion thus obtained is then subjected to shear in order to reduce the diameter of the water bubbles that it contains. This may in particular be carried out by injecting the emulsion into a container, advantageously a mold having the shape and dimensions corresponding to those of the foam that it is desired to manufacture, by means of a syringe connected to a pulser capable of delivering a pressure above atmospheric pressure. Advantageously, this syringe is provided, at its lower end, with a tap for being filled with the emulsion, and then with a needle, for example a metal needle, for injecting said emulsion. Preferably, a needle having an internal diameter of 150 μm to 1 mm is used.

The polymerization of the monomers is preferably carried out hot, that is to say at a temperature of the order of 30 to 70° C., for example in an oven. It can optionally be carried out after having placed the emulsion in a hermetically sealed container in order to avoid possible contamination of this emulsion during the polymerization. The time necessary for the polymerization of the emulsion to result in a solid foam is generally of the order of 12 to 48 hours.

According to another advantageous embodiment of the invention, washing of the foam comprises one or more operations of immersing this foam in water, preferably ultrapure water, followed by one or more operations of immersing it in an alcohol, these operations themselves being followed by one or more alcohol extraction operations, for example in a Soxhlet extractor.

The alcohol used during these operations is preferably ethanol. alcohol extraction operations, for example in a Soxhlet extractor.

The alcohol used during these operations is preferably ethanol.

In accordance with the invention, the foam is preferably dried in an oven, at a temperature of around 60° C., for example for about 12 hours.

Other characteristics and advantages of the invention will become more clearly apparent on reading the remainder of the description which follows, which is given, of course, by way of illustration and without implied limitation and with reference to the appended drawings.

### BRIEF DESCRIPTION OF THE DRAWINGS

FIG. 1 represents three photographs taken using a scanning electron microscope on a sample of a first example of foam in accordance with the invention, part A corresponding to a magnification of ×28, part B to a magnification of ×127 and part C to a magnification of ×1960.

FIG. 2 represents, in the form of a histogram, the frequency (F) of the cells of a sample of the first example of foam illustrated in FIG. 1 as a function of the diameter (D) of these cells, expressed in micrometers.

FIG. 3 represents, in the form of a histogram, the frequency (F) of the pores of a sample of a foam in accordance with the invention as a function of the diameter (D) of these pores, expressed in micrometers.

FIG. 4 represents three photographs taken using a scanning electron microscope on a sample of a second example of foam according to the invention, part A corresponding to a magnification of ×32.3, part B to a magnification of ×126 and part C to a magnification of ×1990.

FIG. 5 shows, in the form of a histogram, the frequency (F) of the cells of a sample of the second example of foam illustrated in FIG. 4 as a function of the diameter (D) of these cells, expressed in micrometers.

FIG. 6 shows, in the form of a histogram, the frequency (F) of the pores of a sample of the second example of foam illustrated in FIG. 4 as a function of the diameter (D) of these pores, expressed in micrometers.

FIG. 7 shows three photographs taken using a scanning electron microscope on a sample of a third example of foam according to the invention, part A corresponding to a magnification of ×30.9, part B to a magnification of ×129 and part C to a magnification of ×1940.

FIG. 8 shows, in the form of a histogram, the frequency (F) of the cells of a sample of the third example of foam illustrated in FIG. 7 as a function of the diameter (D) of these cells, expressed in micrometers.

FIG. 9 shows, in the form of a histogram, the frequency (F) of the pores of a sample of the third example of foam illustrated in FIG. 7 as a function of the diameter (D) of these pores, expressed in micrometers.

### DETAILED DESCRIPTION OF A SPECIFIC EMBODIMENTS

### Example 1

A batch of samples of a first example of polymer foam according to the invention was prepared by following the procedure below.

In a first step, an organic phase was prepared, comprising 12.9 g of styrene (from Aldrich), 3.2 g of divinylbenzene (from Aldrich) and 4 g of diglyceryl monooleate (DCMO-CV from Nikkol).

This organic phase was introduced into the vessel of a glass chemical reactor with a jacket in which a heat-exchange fluid circulates, in the case in point water maintained at 20° C. by a thermostatically controlled bath. The reactor was closed by a leaktight lid pierced by 4 ground-glass necks, a central ground-glass neck of which allows a stirrer shaft to pass through and two side ground-glass necks of which serve to connect the reactor respectively to the end of a pressure-equalizing dropping funnel and to a vacuum pump.

At the same time, an aqueous phase was prepared comprising 0.2 g of aluminum sulfate (Aldrich) and 0.6 g of sodium persulfate (Aldrich) in 290.2 ml of ultrapure water with a resistivity equal to 18.2 MΩ.

This aqueous phase was introduced into the vessel of the reactor via the pressure-equalizing (109 mbar) using the vacuum pump. The stirring was continued for a further 5 minutes and then halted, and the vacuum was broken after standing for 4 minutes.

The emulsion thus formed in the reactor was loaded into a syringe, with a volume of 300 ml, which was closed off at its lower end by a tap and was connected to a TECHCO pulser, model TDS-983D, capable of delivering a pressure of up to 7 bar. Once this loading had been completed, the tap of the syringe was replaced with a metal needle, of 410 μm internal diameter, and the emulsion was injected into a series of glass tubes under a pressure of 4 bar.

These tubes were introduced into plastic bags containing 1 cm³ of ultrapure water. The bags are closed by welding and placed in an oven at 60° C. for 17 hours, at the end of which the tubes were removed from the oven and allowed to cool until their temperature was equal to ambient temperature.

The foam samples contained in the glass tubes were manually extracted therefrom and then placed in a beaker filled with ultrapure water. Four days later, the samples were placed in another beaker, filled with ethanol. They remained for two days therein, and were then placed in a Soxhlet extractor, the flask of which was filled with ethanol, and the flask heated to 92° C. Evaporation followed by condensation of the ethanol ensured that this solvent was circulated through the foam samples for 24 hours. The ethanol of the flask was replenished once and the extraction process restarted for 24 hours.

After this operation, the foam samples were dried in an oven at 60° C. for 12 hours.

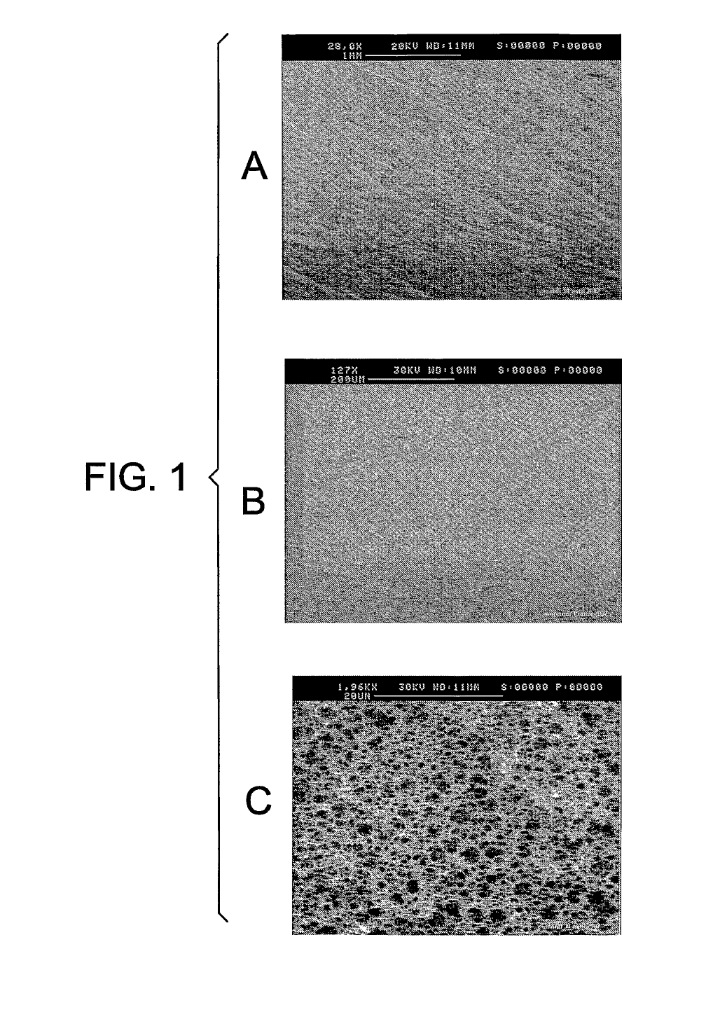

The foam samples thus produced were characterized by:
a mean density of 48.6 mg/cm³±0.1 mg/cm³;
a very homogeneous structure, as is shown in FIG. 1, which represents three photographs taken with a scanning electron microscope, respectively at a magnification of ×28 (part A), ×127 (part B) and ×1960 (part C), on a foam sample;
a mean cell diameter of 2.64 μm±0.46 μm;
a mean pore diameter of 0.58 μm±0.31 μm; and
a mass content of impurities (elements other than carbon and hydrogen) equal to 1.26% (percentages by weight: O=1.12; Na=0.0752; Al=0.064).

The density was determined by subjecting 25 two samples, taken at random, on the one hand to a size measurement using digital calipers (uncertainty of measurement: ±10 μm) and, on the other hand, to weighing (uncertainty of measurement: ±10 μg).

The mean cell diameters and the mean pore diameters were determined over respectively 57 cells and 422 pores using image analysis software from images obtained by scanning electron microscopy.

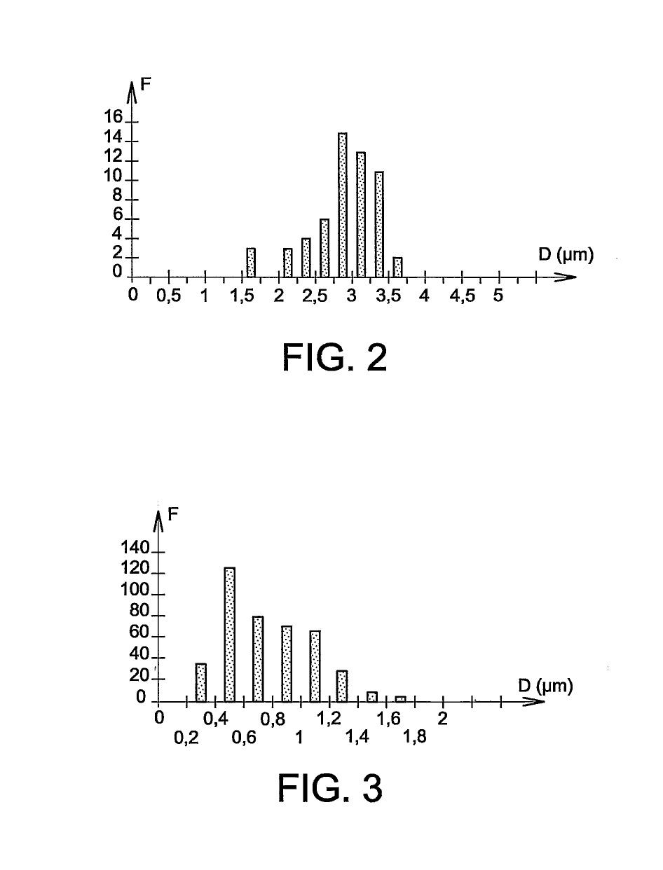

FIG. 2 illustrates, in the form of a histogram, the frequency (F) of these cells as a function of their diameter (D), expressed in μm, while FIG. 3 illustrates, also in the form of a histogram, the frequency (F) of these pores as a function of their diameter (D), also expressed in μm.

### Example 2

A batch of samples of a second example of polymer foam according to the invention was prepared by following a procedure identical to that described in example 1 but using an organic phase comprising 42 g of styrene, 10.5 g of divinylbenzene and 7.9 g of diglyceryl monooleate, and an aqueous phase comprising 0.2 g of aluminum sulfate and 0.5 g of sodium persulfate in 293 ml of ultrapure water.

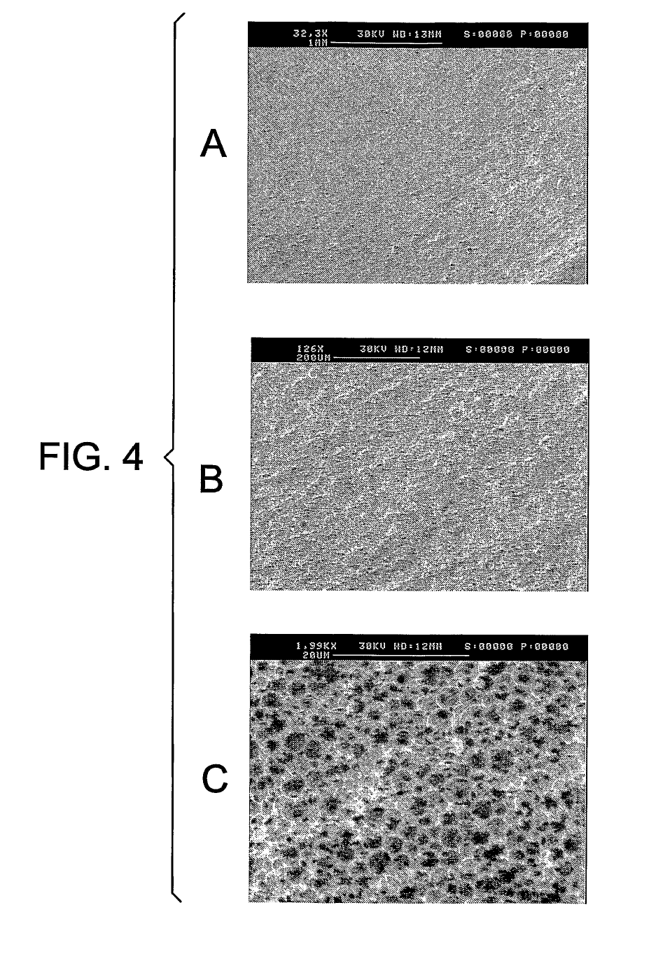

Samples were thus obtained which, subjected to analyses similar to those described in example 1, were characterized by:
a mean density of 159.0 mg/cm³±0.1 mg/cm³;
a very homogeneous structure, as shown in FIG. 4, which represents three photographs taken with a scanning electron microscope, respectively at a magnification of ×32.3 (part A), ×126 (part B) and ×1990 (part C), on a foam sample;
a mean cell diameter of 2.97 μm±0.63 μm (determined over 57 cells);
a mean pore diameter of 0.75 μm±0.31 μm (determined over 151 pores); and
a weight content of impurities (elements other than carbon and hydrogen) of 1.16% (percentages by weight: O=1.09; S=0.029, Na=0.0287; Al=0.0189).

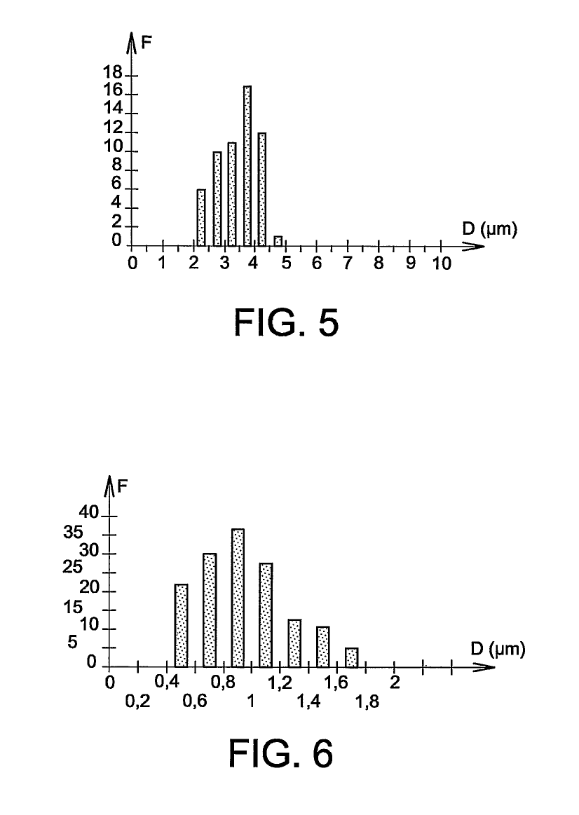

FIG. 5 illustrates, in the form of a histogram, the frequency (F) of these cells as a function of their diameter (D) , expressed in μm, while FIG. 6 illustrates, also in the form of a histogram, the frequency (F) of these pores as a function of their diameter (D) expressed in μm.

### Example 3

A batch of samples of a third example of polymer foam according to the invention was prepared by following a procedure identical to that described in example 1, but using an organic phase comprising 70 g of styrene, 17.5 g of divinylbenzene and 13.1 g of diglyceryl monooleate, and an aqueous phase comprising 0.18 g of aluminum sulfate and 0.467 g of sodium persulfate in 254 ml of ultrapure water.

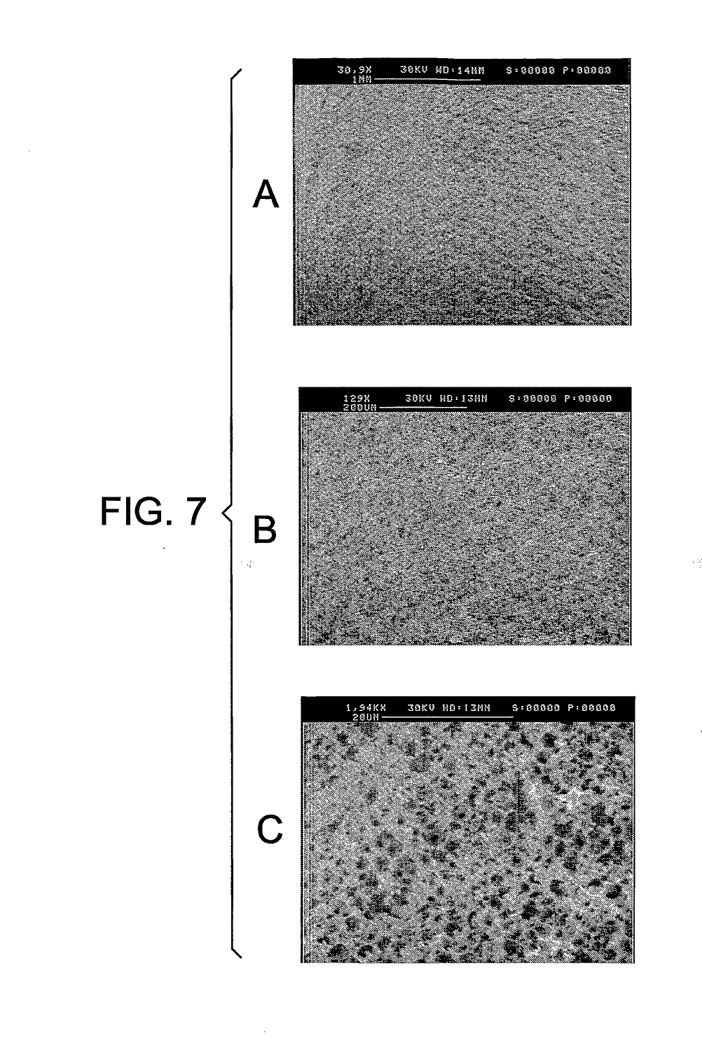

Samples were thus obtained which, subjected to analyses similar to those described in example 1, were characterized by:
a mean density of 256.8 mg/cm³±0.1 mg/cm³;
a very homogeneous structure, as is shown in FIG. 7, which represents three photographs taken with a scanning electron microscope, at a magnification of ×30.9 (part A), ×129 (part B) and ×1940 (part C), respectively, on a foam sample;
a mean cell diameter of 2.93 μm±0.74 μm (determined over 41 cells);
a mean pore diameter of 0.70 μm±0.26 μm (determined over 106 pores); and
a weight content of impurities (elements other than carbon and hydrogen) of 1.29% (percentages by weight: O=1.24; S=0.037; Na=0.0074; Al=0.0077).

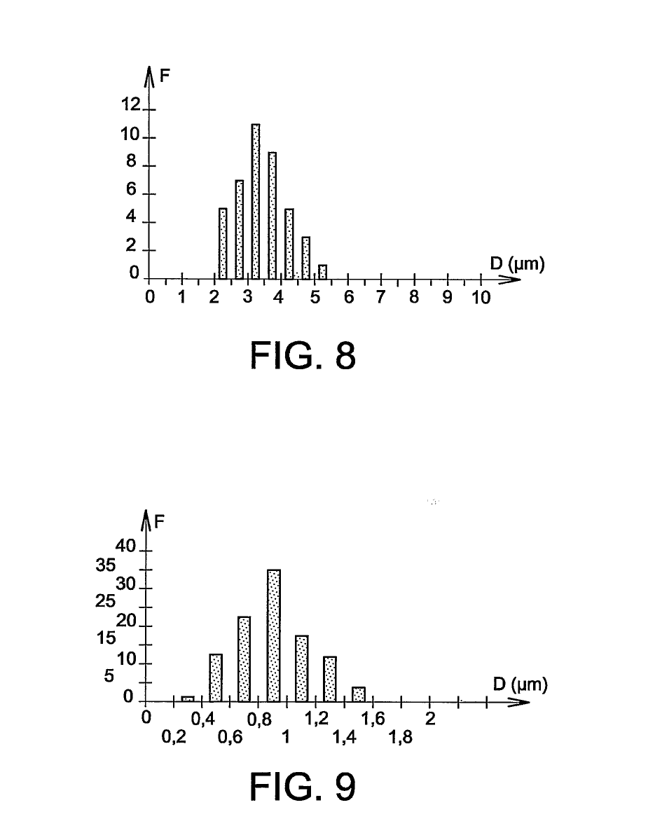

FIG. 8 illustrates, in the form of a histogram, the frequency (F) of these cells as a function of their diameter (D), expressed in μm, while FIG. 9 illustrates, also in the form of a histogram, the frequency (F) of these pores as a function of their diameter (D) expressed in μm.

### BIBLIOGRAPHY

[1] U.S. Pat. No. 5,331,015
[2] U.S. Pat. No. 5,770,634
[3] WO-A-97/37745

1. A polymer foam obtained by highly concentrated internal phase emulsion polymerization, which is formed from a crosslinked, exclusively hydrocarbon, polymer based on styrenic monomers, and has a density of 40 mg/cm³ to 260 mg/cm³ and cells with a mean diameter of 10 micrometers or less.

2. The polymer foam as claimed in claim 1, in which the polymer is a styrene/divinylbenzene copolymer.

3. The polymer foam as claimed in claim 2, in which the styrene/divinylbenzene weight ratio is between 5 and 1.

4. The polymer foam as claimed in claim 1, which has a mean cell diameter of between 1 and 5 micrometers.

5. The polymer foam as claimed in claim 1, in which the elements other than the constituent carbon and the constituent hydrogen of the polymer represent less than 3% by weight of the weight of the foam.

6. A process for the manufacture of a polymer foam as claimed in claim 1, which comprises the following steps:
a) an emulsion between an organic phase, comprising exclusively hydrocarbon styrenic monomers and a surfactant, and an aqueous phase, comprising an electrolyte and a polymerization initiator, is produced, the volume of the aqueous phase representing at least 74% of the total volume of the two phases;
b) the emulsion is subjected to shear in order to reduce the diameter of the water bubbles that it contains;
c) said monomers are polymerized until a solid foam is obtained; and
d) the foam obtained in step c) is washed and dried.

7. The process as claimed in claim 6, in which the styrenic monomers present in the organic phase are styrene and divinylbenzene monomers.

8. The process as claimed in claim 7, in which the weight ratio of the styrene monomers to the divinylbenzene monomers is between 5 and 1.

9. The process as claimed in claim 6, in which the styrenic monomers represent from 50 to 80% by weight of the weight of the organic phase.

10. The process as claimed in claim 6, in which the surfactant is diglyceryl monooleate.

11. The process as claimed in claim 6, in which the surfactant represents from 13 to 20% by weight of the weight of the organic phase.

12. The process as claimed in claim 6, in which the electrolyte is aluminum sulfate.

13. The process as claimed in claim 6, in which the electrolyte represents from 0.05 to 2% by weight of the weight of the aqueous phase.

14. The process as claimed in claim 6, in which the polymerization initiator is sodium persulfate.

15. The process as claimed in claim 6, in which the polymerization initiator represents from 0.1 to 2% by weight of the weight of the aqueous phase.

16. The process as claimed in claim 6, in which the water used for preparing the aqueous phase is water having a resistivity of about 18.2 megaohms.

17. The process as claimed in claim 6, in which step b) is carried out by injecting the emulsion into a container by means of a syringe connected to a pulser capable of delivering a pressure above atmospheric pressure.

18. The process as claimed in claim 17, in which the container is a mold having the shape and the dimensions of the foam that has to be manufactured.

19. The process as claimed in claim 17, in which the syringe is provided with a needle having an internal diameter of 150 μm to 1 mm.

20. The process as claimed in claim 6, in which the polymerization of the monomers is carried out at a temperature of around 30 to 70° C.

21. The process as claimed in claim 6, in which the washing of the foam comprises one or more operations of immersing this foam in water, followed by one or more operations of immersing it in an alcohol, which are themselves followed by one or more alcohol extraction operations.

22. The process as claimed in claim 6, in which the foam is dried in an oven at a temperature of about 60° C.
